(19) United States
(12) Patent Application Publication
(10) Pub. No.: US 2005/0289041 A1
(43) Pub. Date: Dec. 29, 2005

(54) System and method for computing the should be purchase cost of a product

(75) Inventor: Subhash Chowdary, San Jose, CA (US)

Correspondence Address: William L, Botjer, PO Box 478, Center Moriches, NY, 11934, US

(73) Assignee: AANKHEN, INC., SAN JOSE, CA (US)

(21) Appl. No.: 10/876,920

(22) Filed: Jun. 25, 2004

(51) Int. Cl. G06F 17/60

(52) U.S. Cl. 705/37

(57) ABSTRACT

A system and method to provide a buyer with what the purchase cost should be for a part that needs to be procured from a supplier. Knowledge of what the cost should be enables the buyer to negotiate with the supplier, relying on accurate and fact-based data before approving a negotiated price. The supplier provides information about the price for the part through an interface over the Internet. Purchasing professionals at the buyer's end collect and store cost information obtained from various sources other than the supplier. This cost information is represented in a hierarchical manner. The should be purchase cost is calculated as a function of factors involved in the cost hierarchy. The difference between the price provided by the supplier and the should be purchase cost presents the buyer with potential savings opportunities, before making pricing decisions during negotiations.

### BACKGROUND

The present invention relates to a purchasing support system. More specifically, the present invention is a system and method, which supports a buyer in making purchase and price-approval decisions.

In the current extremely competitive global economy with diminishing margins, cost management is critical for the survival of an enterprise. This is especially true of manufacturing companies or companies that procure various goods or services to carry out their operations. The entire process of procurement and delivery of goods or services from a supplier to a manufacturer depends on various factors. These factors could be transportation via a desired mode (land, air, and ocean), type of storage, packaging, and other factors. All the factors and processes involved in the selection, negotiation and approval of the total price of the delivery of goods or services from the supplier to the manufacturer together form a supply chain. A supply chain refers to physical, financial, and information networks, including the movement of materials, funds, related information, and resources involving all vendors, service providers, customers and other agents.

For a manufacturing company, the costs involved in the procurement of components, parts, material, and services form a large portion of its expenditure. Increased reliance on global sourcing changes the dynamics of the total cost of procured materials. This makes the management of these costs absolutely critical. Companies have increasingly started to realize the importance of cost-management in the field of procurement. Large amounts of profits can be generated if strategic cost management processes are adopted. Traditional approaches for achieving effective cost reduction rely on the analysis and understanding of spending-data from internal and external information sources.

In existing supply-chain cost-management systems, a buyer has to rely on multiple sources to obtain pricing information. The information sources include supplier websites, intermediate personnel and agents. The pricing information comparisons for the various components, materials and services, offered by different suppliers, help in making informed decisions regarding supplier selection. Most of the information is collected as a result of the intensive manual effort put in by the purchasing professionals (logistics analysts, commodity managers, buyers, planners, purchasing executives, and financial executives) across a geographically distributed organization.

Consolidation of the total costs from disparate sources is accomplished by using multiple spreadsheets and applications involving extensive manual effort for every price-negotiation cycle. Manual efforts for analyzing and consolidating various costs, using these spreadsheets, leads to varied opinions and inferences about the cost-related facts. The varied opinions and inferences, taken out of context, result in disagreement and confusion while making pricing decisions. For instance, there may be different interpretations of the context in which the price was negotiated in the past with the supplier. Such confusions create a need for the reconciliation of submitted documents (purchase orders, invoices, etc.) for payment, settlement and adjustments to payments, for the purpose of confirming the actual negotiated price. The manual collation of data is also time-consuming and prone to errors, loss of context and potential mismanagement.

In systems like the one described above, purchasers have to rely on the prices quoted by the supplier. In some cases, where more than one supplier is available to satisfy the requirements of a manufacturer, a Request For Quote (RFQ) may be sent to all the potential suppliers. The RFQ is an invitation for vendors or suppliers, to bid on supplying components, materials or services described by the buyer. On receiving the bids from the suppliers, the manufacturer compares their quotes, and generally, the supplier who quotes the minimum price, all other factors being equal, is selected. However, since the source of obtaining the prices of the products is the supplier, further cost-reduction opportunities for the purchaser may remain unexplored. This is because the purchaser simply accepts the quoted price, without further analyzing the various components of the costs involved. This translates to significant higher costs resulting in losses for the purchaser.

In order to avoid losses due to the lack of visibility to accurate and complete facts and costs, it is important for decision makers in an enterprise to be well informed about the actual costs of the components, materials, or services being purchased. The purchaser should be aware of the detailed cost components of the price quoted by a supplier. With the help of accurate facts, the buyer can discover and utilize cost-reduction opportunities for negotiating with the supplier.

In existing systems, negotiations with the supplier are carried out in a fragmented manner, wherein purchase professionals from different departments in different geographic regions negotiate different components of the total cost, such as material cost, freight cost, storage costs, packaging costs, warranty, or other, with the corresponding individual(s) from the supplier's side. This process of negotiation is cumbersome and error-prone.

Several efforts have been made to overcome some of the problems mentioned above. The efforts made to date focus on a rear-view mirror approach to analyzing what has been already spent. At present there are some systems that offer automated methods for supplier-cost analyses or spending data categorization and management. These systems help in reducing the errors in efforts made manually. These systems require extensive investments in the process of gathering and analyzing data relating to expenditures that have already been made. The systems offer limited help to the purchasing enterprise to monitor price and cost trends because inconsistent data of poor quality, with little or no context, is used. Automated spend management systems help purchasing professionals create spend-management strategies for cost reductions. Spend-management strategies based on databases that automatically collect and collate information are focused on analyzing total supply base spends and rationalizing supplier relationships. However, total supply base spends only relate to the aggregated expenditures already made in the past. Supply base spends do not address the total cost that should be negotiated with a supplier for each future purchase of components, materials or services.

An example of existing systems, that have made an attempt to overcome the above-mentioned problems, is described in U.S. Patent Application No. 20030130878, titled ‘System and Method for Managing Spending’. This application discloses a system and method for spend management. According to the system mentioned in this patent, a variety of procurement related data is first collected. Procurement data includes information about suppliers, products, prices, rebates, margins, and dates. The information is then analyzed and presented to a user, in relation to a particular procurement event that the user may be interested in. This patent application elaborates on a method for collecting, storing, analyzing and presenting supplier-related information for historical procurement events. However, the method and system of this application fails to collect and/or examine pricing details in terms of the price of products or services, carrier services, storage, warranty, etc., so as to achieve cost reduction before the occurrence of a future procurement.

Another patent application, that addresses a similar issue, is U.S. Patent Application No. 20020156663, titled ‘Shipping and Transportation Optimization System and Method’, assigned to Manugistics, Inc. This application discloses a system and method to determine optimal supply-chain configurations. According to the system, varied conditions in a supply-chain model are specified, so as to derive an optimal, cost-minimizing set of supply-chain decisions. The system computes changes in costs and profits from geographic changes in the supply chain, or from the substitution of goods and resources within the supply chain. This system also compares multiple alternatives within a supply chain, to improve asset utilization. According to the disclosed method, the user provides information about the geographic locations of supply chain elements, lanes defining transportation network connecting the locations, items and resources in the supply chain, or any other specification. However, the system determines various optimal cost details, based on ‘what-if’ conditions internal to an enterprise, and not on facts, to create a model. The cost details provided by the system are independent of time phases and are not applicable when these cost details are yet to be negotiated. In price negotiations, the prices quoted by each supplier must be applied for a specific time period in the future, dynamically in the context of each supplier negotiation. In global procurement today, changes to costs occur faster than the time to model them.

WIPO Publication No. WO03046696, titled ‘Supply Chain Network’, assigned to Isupply Corporation, discloses a supply-chain network. The supply-chain network consists of a server that handles several management activities for all the individuals involved in a supply chain. Among several management tasks, the server also performs the task of negotiating prices, terms and conditions by providing an interface for suppliers and purchasers. This server provides a ‘many-to-many’ relationship where customers, suppliers, logistics personnel, carriers, and financial institutions may interact. The interaction between various individuals in the network is based on generic information. The information available on the network, or that supported by the server, is not specific to the context and costs relating to a particular negotiation. In addition, the process of validating a price for competitiveness, for the purpose of negotiations, does not involve the breaking up of the prices provided by the supplier into its details. As a result, several opportunities for cost savings may remain undiscovered.

In global procurement negotiations, prices quoted for the same item may vary depending on the leverage of the buyer in the industry. For example, for the same product, Company A may get a different price quote than Company B or Company C.

From the above discussion, it is evident that there is a need for an efficient and accurate cost-computation system to support procurement-pricing decisions during negotiations with a supplier, before a buyer approves the negotiated prices. The system should also form relationships between cost-related data collected from various sources and by different purchasing professionals, to maintain one set of facts and not multiple versions of the facts. The system should represent different costs and rates in a time-phased manner to enable computation of costs for different time periods. There also exists a need for a method and system to support closed-loop cost negotiations between the buyer and the supplier, dynamically, in real time, since various costs are changed during the negotiations. Furthermore, it is desirable to have a method and system for analyzing the components of the costs involved in the procurement of a part in detail, so that cost-reduction opportunities can be uncovered.

### SUMMARY

The present invention is directed at a method, a system, and a computer program for calculating and displaying what a product should cost, so that a buyer can negotiate with a supplier on the basis of accurate and fact-based data.

An object of the present invention is to create and maintain relationships between data elements, structures, business entities and users, so as to reliably compute the should be purchase cost.

Another object of the present invention is to compute and display the cost of a product, after bringing together, in-context, the different costs factors provided by a range of users, and arranging these costs hierarchically.

Another object of the present invention is to provide a method, a system and a computer program for a time-phased representation of values that can be independently set for different rates or costs for varied geographic locations.

A further object of the present invention is to provide a method, a system and a computer program, to enable a closed-loop negotiation process wherein varied levels of security are enforced at an individual user level, on the basis of the role of the user, to authorize user access to the information and negotiation functions.

A system, in accordance with the present invention, comprises a user interface provided to a supplier; a user interface provided to a buyer; a server for collecting, processing, and presenting information relating to cost collected from the supplier and the buyer; and a memory for storing various cost information and their relationships. The supplier accesses the user interface over the Internet after authentication. The user interface enables the supplier to upload or enter pricing information for a product. The pricing information is collected by the server and stored in the memory, along with a time stamp. The time stamp consists of the date and time at which the information was uploaded, along with the time period for which the uploaded information will be valid. The buyer accesses the user interface over an internal network. A number of purchasing professionals from the buyer's enterprise may also be involved in uploading of pricing information for a product. Each purchasing professional is authenticated differently according to the role of the purchasing professional, who may collect and upload or enter cost information consisting of several cost components involved in the procurement of the product from the supplier. The cost information is collected by the server and stored in the database, with an effective time period for each cost component. The server facilitates the formation of relationships between pricing information collected from the supplier and cost information provided by the purchasing professionals, and storing these relationships in the database. Further, the server processes cost information in such a manner that the should be purchase cost of the product can be computed.

The should be purchase cost of the product is compared with the pricing information provided by the supplier to compute savings opportunities. The buyer negotiates with the supplier with the knowledge and visibility to all costs in negotiation and the computed should be purchase cost of the product. Therefore, the present invention supports the buyer with purchasing decisions, and facilitates proactive cost-savings by determining what the cost of procurement should be.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram of an exemplary environment, in accordance with an embodiment of the present invention;

FIG. 2 is a block diagram of an exemplary environment, in accordance with an embodiment of the present invention;

FIG. 3 is a block diagram of various system elements of enterprise server 102, in accordance with an embodiment of the present invention;

FIG. 4 is an illustration of an interface shown to a pricing owner, in accordance with an embodiment of the present invention;

FIG. 5 is an illustration of an interface shown to a logistics analyst, in accordance with an embodiment of the present invention;

FIG. 6 is a flowchart that illustrates the steps performed to calculate the should be purchase cost of a product, in accordance with an embodiment of the present invention;

FIG. 7 illustrates an exemplary cost hierarchy of the should be purchase cost of a product;

FIG. 8 is a block diagram showing the various entities of a pricing-record subject area;

FIG. 9 is a block diagram showing various entities of the source split-subject area;

FIG. 10 is a block diagram showing various entities of the packaging-profile subject area;

FIG. 11 is a block diagram showing various entities of the rates and fees subject area;

FIG. 12 is a block diagram showing various entities of a logistics facts subject area.

### DESCRIPTION OF PREFERRED EMBODIMENTS

The disclosed invention is a method and system for computing the should be purchase cost of a product. The should be purchase cost indicates to the buyer of the product what the cost of a product should be. The should be purchase cost of the product can be used to negotiate the approved price of the product with a supplier. The should be purchase cost, and the methodology involved in calculating the same, gives the buyer a complete and accurate analysis on the basis of which the buyer can negotiate the purchase price of the product with the supplier.

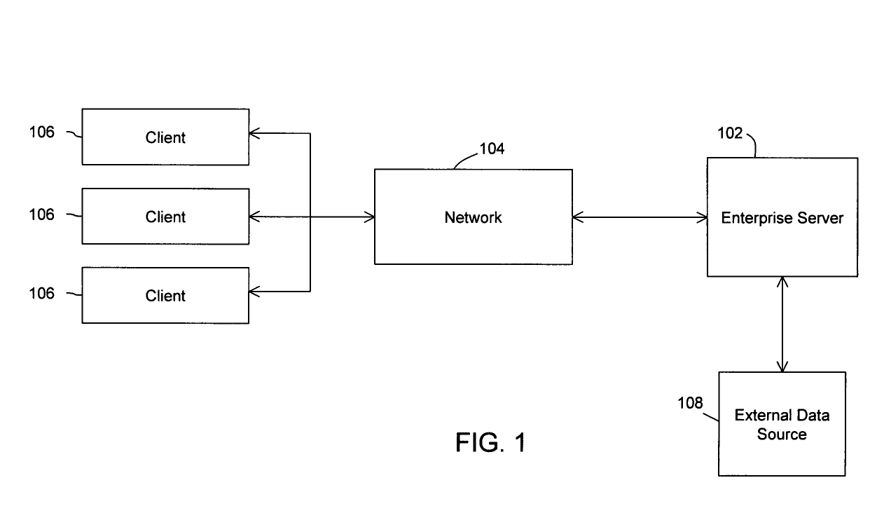

FIG. 1 is a block diagram of an exemplary environment, in accordance with an embodiment of the present invention. The environment of the invention comprises an enterprise server 102, a network 104, and a plurality of clients 106. Enterprise server 102 comprises one or more data-processing systems capable of executing programmed instructions and communicating over network 104. Examples of network 104 include a local area network, wide area network, and the Internet. One or more clients 106 use network 104 to connect to enterprise server 102. Client 106 is a data-processing system capable of communicating with other data processing systems over network 104. Enterprise server 102 is also connected to an external data source 108. In a specific embodiment, external data source 108 can be an enterprise resource-planning software, an information management system, an external database, and the like.

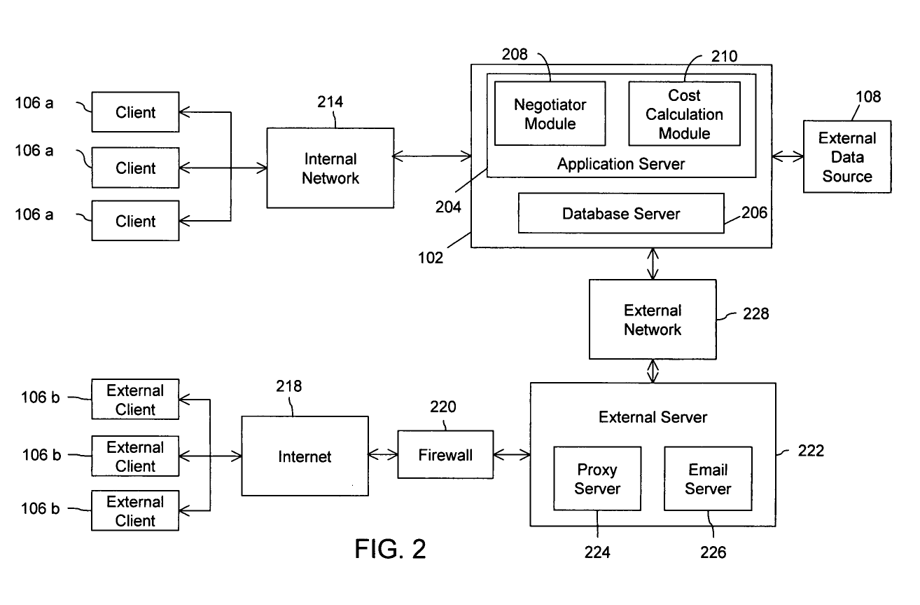

FIG. 2 is a block diagram of an exemplary environment of an embodiment of the present invention. Enterprise server 102 comprises an application server 204 and a database server 206. Application server 204 comprises a negotiator module 208 and a cost calculation module 210. These modules are implemented on application server 204. There are two types of clients that access enterprise server 102. They are internal clients 106a and external clients 106b. Users that use internal clients 106a comprise logistics analysts, commodity managers, buyers and various other types of users within an organization, and are referred to as internal users. Internal users use internal network 214 to connect to enterprise server 102. Enterprise server 102 uses a security service to authenticate internal users. In a specific embodiment, Internet Information Services (IIS) security is used as the security service to authenticate the users. Once the internal users are authenticated, they can access application pages running on application server 204. External clients 106b are used by users comprising business partners and suppliers, and are referred to as external users. External users access enterprise server 102 via Internet 218. The access requests are first transmitted to a firewall 220 and then to an external server 222. External server 222 comprises a proxy server 224 and an email server 226. Proxy server 224 relays the requests to enterprise server 102, using external network 228. Enterprise server 102 uses a security service, as described previously, to authenticate external users. In a specific embodiment, the authentication can be based on the username and password provided by the external users. After the external users have been authenticated, the security service grants external users access to application pages running on application server 204. In an alternate embodiment, it is also possible for internal users to access enterprise server 102 by using external clients 106b, and similarly, it is possible for external users to access enterprise server 102 by using internal clients 106a.

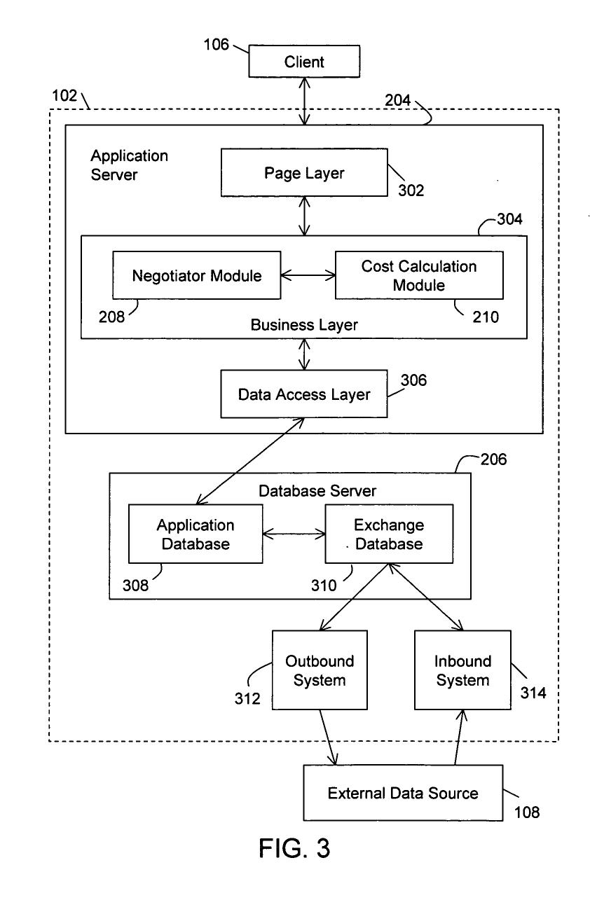

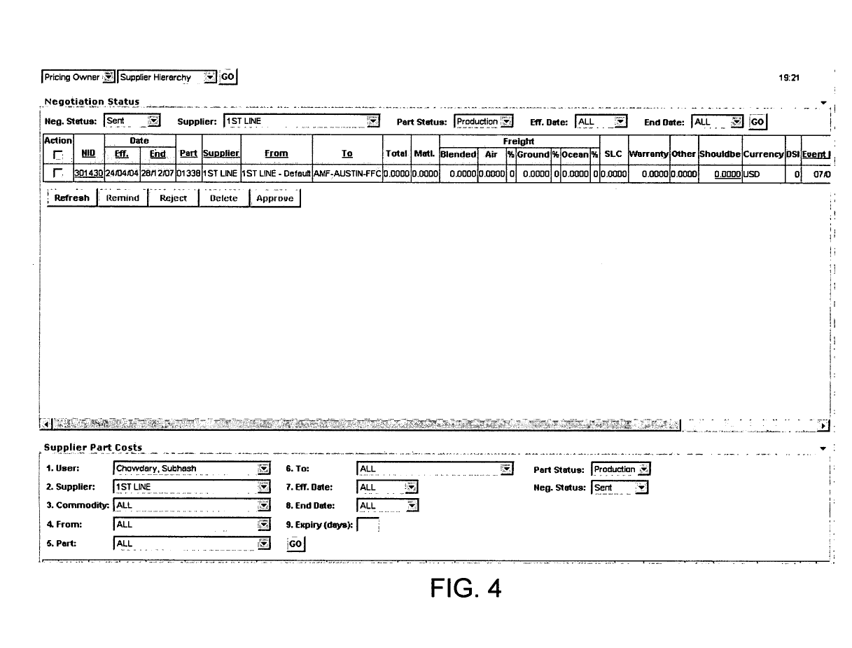

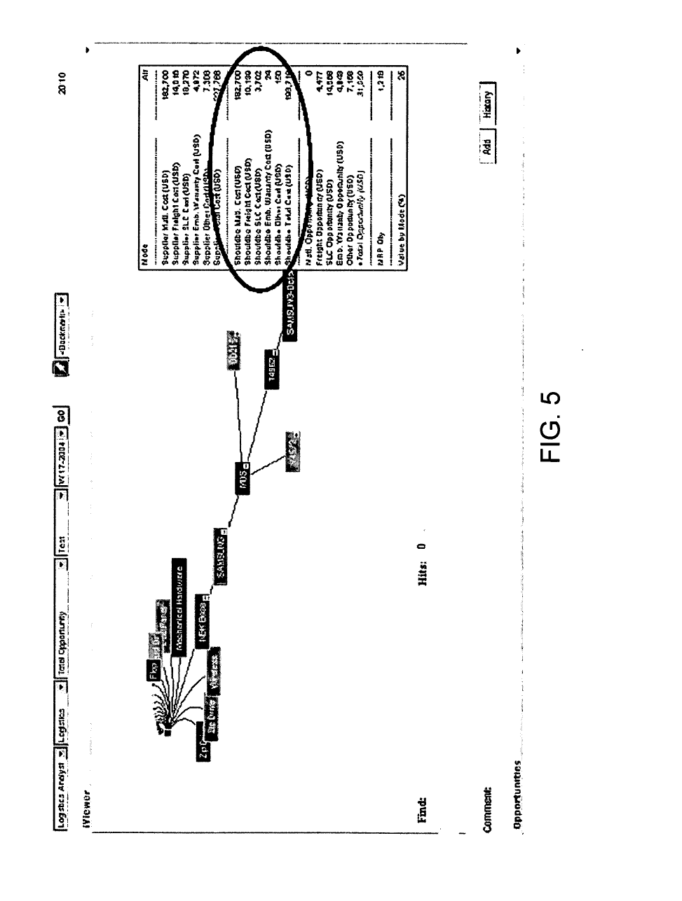

FIG. 3 is a block diagram of the various system elements of enterprise server 102, in accordance with an embodiment of the present invention. As described earlier, enterprise server 102 comprises an application server 204 and a database server 206. Application server comprises a page layer 302, a business layer 304, and a data access layer 306. Internal as well as external users connect to application server 204. Application server 204 receives requests from the users to store, retrieve or process data. In an embodiment of the present invention, the requests can be in the form of web browser requests, that are generated by web browsers running on clients 106. The requests can be in the form of authorization requests or requests for data. Before a user can request for data, the user has to be authenticated by application server 204. Once a user has been authenticated, application server 204 presents the user with a user-specific interface. In an embodiment of the present invention, the user-specific interface is in the form of a custom webpage that can be accessed by a user through a web browser running on clients 106. The authorization of the user is used to decide the content the user views and the inputs the user can provide. For example, a pricing owner will view different content from that viewed by a logistics analyst. This is because both these users have different permissions and roles within enterprise server 102. FIG. 4 is an illustration of an interface shown to a pricing owner, in accordance with an embodiment of the present invention. A pricing owner can view the negotiation status of a product. The interface also presents the should be purchase cost of the product which the pricing owner can use to negotiate the purchase cost of the product. FIG. 5 is an illustration of an interface shown to a logistics analyst, in accordance with an embodiment of the present invention. A logistics analyst can view a relationship hierarchy, related to a product and the costs associated with the product.

In a specific embodiment of the present invention, page layer 302 is used to generate custom Active Server Pages (ASPs) for authenticated users. Business layer 304 comprises negotiator module 208 and cost calculation module 210. These modules are utilized to perform functions that are used for computing the should be purchase cost of a product, and are discussed in the later sections of this description. Business layer 304 communicates with page layer 302 to generate a relevant interface that is presented to a user. With the help of this interface, a user can input information related to the cost of a product and view stored details. The interaction is in the form of queries and requests that are processed by business layer 304. Business layer 304 then directs the queries and requests to data access layer 306. Data access layer 306 is used to communicate with database server 206. In a specific embodiment, this layer performs tasks such as Structured Query Language (SQL) manipulation, the generation and translation of MultiDimensional expressions (MDX expressions) and extensible Markup Language (XML) parsing. Hence, data access layer 306 is used to store data entered by users in a database, and present to users stored data from a database.

Database server 206 comprises an application database 308 and an exchange database 310. In an embodiment of the present invention, application database 308 receives SQL queries from data access layer 306. Application database 308 acts as a primary storage database for all the application content of the present invention. Exchange database 310 acts as a secondary storage database. Application database 308 communicates with exchange database 310 in the form of Data Transform Service (DTS) packages, in an embodiment of the present invention. DTS packages are primarily used to insert, update and delete content on exchange database 310. They can also be used to perform operations on application database 308.

Enterprise server 102 also supports communication with external databases and applications. These features are provided by an outbound system 312 and a source system 314. Outbound system 312 is used by exchange database 310 to export information to external databases and third-party software applications. In a specific embodiment, exchange database 310 sends outbound DTS packages to outbound system 312, in order to export cost information and other data. Exchange database 310 can also import cost information and data from external data sources 108. This is carried out in conjunction with source system 314. Source system 314 reads data from a desired source, such as an enterprise resource planning software database, and sends this information to exchange database 310 in the form of inbound DTS packages. The inbound DTS packages are read by exchange database 310 and relevant information is extracted and saved.

In an embodiment of the present invention, application server 204 uses one or more of the following software applications: Microsoft™ IIS Web Server™, Microsoft Windows™ Sharepoint services, Microsoft™ SQL Server 2000, Microsoft™ Analysis Services 2000, Microsoft™ XMLA MDX Web Service, Microsoft™ MQ Private and Microsoft™ NET 1.1. Database server 206 requires Microsoft™ SQL Server 2000, Microsoft™ Analysis Services 2000, Microsoft™ MQ Private and Microsoft™ NET 1.1. These examples are only for illustration purposes and in no way limit the scope of the invention.

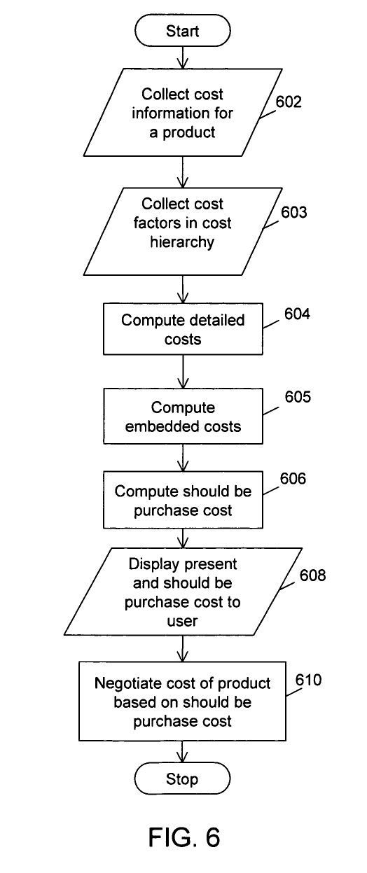

FIG. 6 is a flowchart that illustrates the steps performed to calculate the should be purchase cost of a product, in accordance with an embodiment of the present invention. At step 602, cost information relating to a product is collected and uploaded on database server 206. This step is a function of negotiator module 208. The cost information of a product is the information that is supplied by a supplier of a product. This information is specific to a particular product that is to be shipped to a particular location. The user who enters this information also specifies a time duration for which the information is valid. At step 603, cost factors relating to the product are collected and stored at database server 206. This step is performed by cost calculation module 210. The cost factors of a product comprise costs such as material costs, storage costs, freight costs and other costs. These costs are further broken down and are expressed as the functions of the packaging information of the product and associated rates. Various users are authorized to input specific cost details. After all the requisite information has been uploaded by the designated users, or imported from external data sources 108, a number of detailed costs related to the product are calculated at step 604. Detailed costs of a product are obtained as a function of one or more cost factors. After obtaining the detailed costs of a product, embedded costs of the product are obtained by summing the various detailed costs according to the cost hierarchy at step 605. At step 606, the should be purchase cost of a product is calculated. These steps are also performed by cost calculation module 210. The total should be purchase cost is calculated by summing up the various embedded costs such as material costs, storage costs, freight costs and other costs. At step 608, the total should be purchase cost of a product is presented to a user. In a specific embodiment, the total should be purchase cost of a product is displayed to the user along with the cost details. Only those users with the authorization to view the should be purchase cost of a specific product are able to view the same. This step is performed by negotiator module 208. At step 610, the should be purchase cost of a product is used by a negotiator to negotiate the actual purchase cost of the product with a supplier of the product.

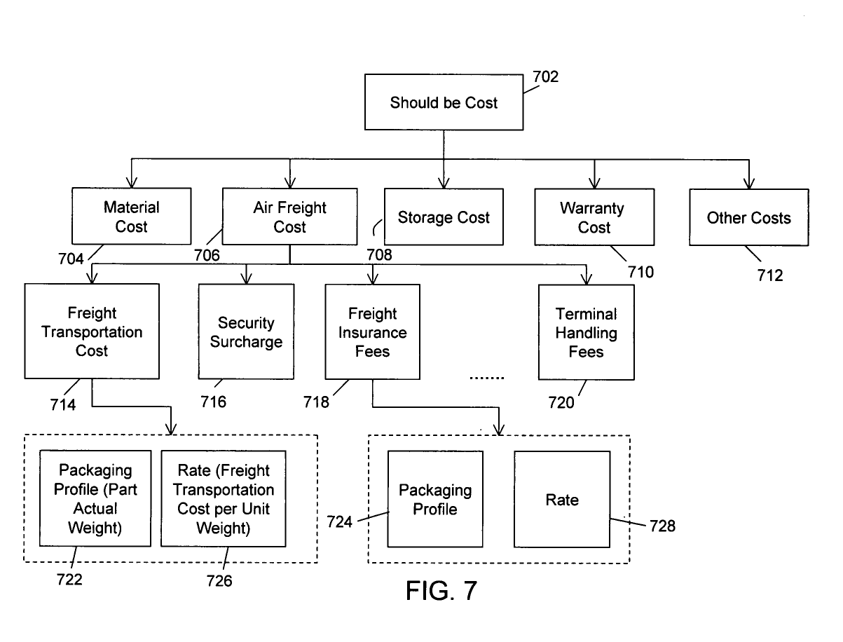

The present invention is adapted to compute the total should be purchase cost at which a product should be purchased. The cost comprises various embedded costs that, in turn, comprise several detailed costs. Embedded costs referred to in this invention include all costs other than material cost, such as freight, storage, warranty, miscellaneous, or any other. FIG. 7 illustrates an exemplary cost hierarchy of the should be purchase cost of a product. Should be purchase cost 702 comprises several embedded costs, including but not limited to material cost 704, air freight cost 706, storage cost 708, warranty cost 710, and other costs 712. Each of the embedded costs is further divided into multiple detailed costs. For example, air freight cost 706 is further divided into freight transportation cost 714, security surcharge 716, freight insurance fees 718, and terminal handling fees 720. Each of the detailed freight costs can be a function of the packaging profile 722 and 724 of a product and various rates such as 726 and 728. The packaging profile is a set of characteristics of the product, carton, pallet, container and packaging metrics. The packaging profile is used to determine the detailed costs of the product in the context of should be freight cost. Packaging profile is also used to determine the part dimensional weight for transport of the product by air mode, the number of units per trailer for transport by ground mode and number of units per container for transport by ocean mode. The rates that are used to determine various detailed costs include brokerage fees, handling fees, duties, interest rate and depreciation rate. It should be apparent to one skilled in the art that the examples of the various embedded costs, detailed costs, packaging profiles and cost factors stated above are for illustrative purposes only and do not limit the scope of the invention in any way.

The computation of the should be purchase cost of a product is further explained by way of the following example:
Total should be purchase cost=Material cost+Blended Freight cost+Storage cost+Warranty cost+Other costs;

In this example, the embedded costs include material cost, blended freight cost, storage cost, warranty cost and other costs. Material cost includes detailed costs such as the cost of the material, labor costs and profits. In this case, the labor cost can be a function of the packaging profile of the product, as it can determine the labor required to pack a unit of the product. The blended freight cost can be a function of airfreight costs, ground freight costs and ocean freight costs. Thus, the blended freight cost may be represented by the following equation:

$$Blended freight cost = ( Percentage of volume by air ) * ( Air freight cost ) + ( Percentage of volume by land ) * ( Ground freight cost ) + ( Percentage of volume by ocean ) * ( Ocean freight cost ) .$$

Also, the storage cost is the cost of storing product at a hub. The warranty cost is the cost paid to supplier for warranty coverage. Other costs are the miscellaneous costs that are not included in the embedded costs mentioned above.

The detailed costs can also be further divided into cost factors such as freight transportation costs, fuel surcharge, brokerage fees, and an extensible variety of other costs. Each of these cost factors can depend on the packaging profile of the product and rates associated with the product. For example, the detailed cost, freight transportation cost 714, for each product can be expressed as a function of packaging profile and rate in the following manner:
Freight transportation cost per unit product=(Greater of Product actual weight or Product dimensional weight)*Freight transportation cost per unit weight
wherein, calculation of product weights are part of packaging profile of the product, and the freight transportation cost per unit weight is a rate.

In another example, the detailed cost freight insurance fee, for air freight, can be calculated in with the following equation:
Freight insurance fee per unit product=(Material cost+Freight transportation cost)*(Depreciation rate/100)*(Interest rate/100)

In the above example, the freight transportation cost is a function of packaging profile and rates as shown in the previous example. Further, depreciation rate and interest rate are a part of rates.

These examples are for illustration only, and do not limit the scope and spirit of the present invention.

Hence, to calculate the should be purchase price of a unit of the product, all of the above stated factors are computed in context. Once all of the detailed costs are computed, they are summed up to obtain the various embedded costs. The embedded costs are also summed up to obtain the should be purchase cost of a product. However, the present invention is not limited to the technique of summing, to arrive at the embedded summary cost. For example, to compute the should be freight cost, the blended freight cost has to be computed. There are three modes of freight: air, ground and ocean. The negotiated percentage of the freight mode indicates the distribution of the purchase volume that is used to transport the material. Applying the distribution percentage a blended freight should be purchase cost is computed. The blended should be freight cost is the embedded freight cost summation. In the cost details of embedded costs, each cost detail may be a computed value dependent on the value of shipped volume, such as insurance.

As discussed earlier, there are two different types of users that access enterprise server 102. They are internal users and external users. There are two separate modules within enterprise server 102, that process requests from the two different types of users. The modules are negotiator module 208 and cost calculation module 210. Requests from external users, to input supplier cost information relating to a product, is handled by negotiator module 208. Cost information includes quoted prices for a given product. These prices are specified along with a time period during which these prices are valid. The prices are input by a supplier of a product via a user interface presented to the supplier by negotiator module 208, or imported from external data sources 108. For the supplier to be able to access enterprise server 102, a username and password is provided to the supplier. With the help of the username and password, suppliers can log-on to enterprise server 102 via the Internet or any other suitable means. In case the supplier is not able to input cost information to enterprise server 102, alternate means of incorporating data provided by the supplier, such as via email and manual means is also possible with the help of authorized internal users.

If it is so desired, multiple suppliers can be selected for a single product. All of the selected suppliers are sent requests, asking for the cost information of the selected product. The location to which the product is to be supplied is also specified, and for a given location, one or more suppliers can be selected. Only the suppliers authorized to supply the product are given permission to provide the cost information of the product to be shipped to the particular location.

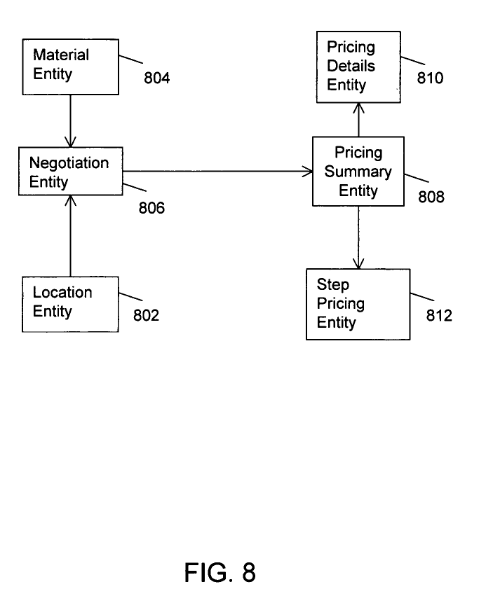

Negotiator module 208 has two subject areas: pricing records and source splits. The pricing record subject area holds information relating to the pricing information provided by the supplier of a given product. FIG. 8 is a block diagram showing various entities of the pricing record subject area. Database records are maintained for each subject area along with a time period during which they are valid. The different entities of the pricing records subject area are material, location, negotiation, pricing details, step pricing and pricing summary. A location entity 802 represents the locations for which the product will be negotiated, which include the various locations to which the specified product can be shipped from a specified supplier.

A material entity 804 is used to identify the material or product for which the cost will be negotiated. This entity is also used to maintain the unit price of the material, as well as the status of the product, such as production or service. Material entity 804 and location entity 802 provide inputs to a negotiation entity 806. Negotiation entity 806 stores a list of valid shipping lanes for a combination of materials and its valid locations. Hence, negotiation entity 806 identifies a list of the various combinations of shipping routes that are possible for a given material or product, to be shipped to a specific location.

Negotiation entity 806 is used to maintain a pricing summary entity 808. This entity stores the actual pricing records of a particular shipping lane. Pricing summary entity 808 is used to provide inputs to a pricing details entity 810 and a step pricing entity 812. Pricing details entity 810 stores the pricing of a given product, identified by material entity 804, at a more detailed level. Step pricing entity 812 is used to store pricing details that are varied by varying volume or the quantity of the product to be shipped.

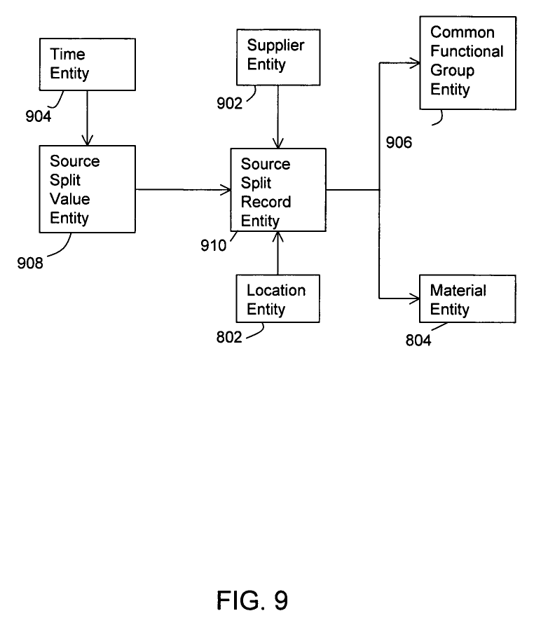

FIG. 9 is a block diagram showing various entities of the source split subject area. The various entities in this subject area are location, material supplier, time, common functional group, source split value and source split record. Location entity 802 and material entity 804 are also part of pricing records subject area. A supplier entity 902 is used to maintain a record of the registered suppliers of the location and material, identified by location entity 802 and material entity 804. A time entity 904 identifies a time period during which the supplier source split is valid. A common functional group entity 906 is required to group common materials from different suppliers under one group. This helps in organizing source split records into appropriate sets for common materials or products. A source split value entity 908 holds the actual split value of a source split record entity 910. Source split record entity 910 stores the planned production usage information of a product at a more detailed level than that offered by pricing summary entity 808. The additional details include supplier information, partner information and comments.

Pricing record and source split subject areas are used by negotiator module 208 to maintain records relating to cost information provided by a supplier of a product. This data is used in negotiating a preferential price for a product, based on the share of purchased volume to be sourced from multiple suppliers of the same item. A supplier provides pricing data, and internal users maintain source split data.

Once all supplier cost information required by negotiator module 208 has been uploaded in database server 206, internal users such as negotiators can start a cost negotiation process with the supplier. Initially, the administrator of the system assigns one or more negotiators for a specific product to be shipped to a given location from a list of suppliers. The selected negotiator can start negotiating on the purchase price of a product with the supplier of that product. In order to negotiate the cost of a product, the negotiator can use the computed should be purchase cost of the product, that is calculated by using cost calculation module 210.

In order to calculate the should be purchase cost of a product, various cost details of the product should be input to cost calculation module 210. The various costs that need to be entered are in a hierarchical structure, as explained in FIG. 7. Cost calculation module 210 presents customized user interfaces to multiple users to input these costs. The reason for this is that different users have access permissions to different cost information, for a given product to be delivered to a given location by using a specified logistics lane. The cost details are entered by different users in a user interface presented to the users. The interface is generated by application server 204. Application server 204 accepts information from a user based on the authorization level of the user inputting the information.

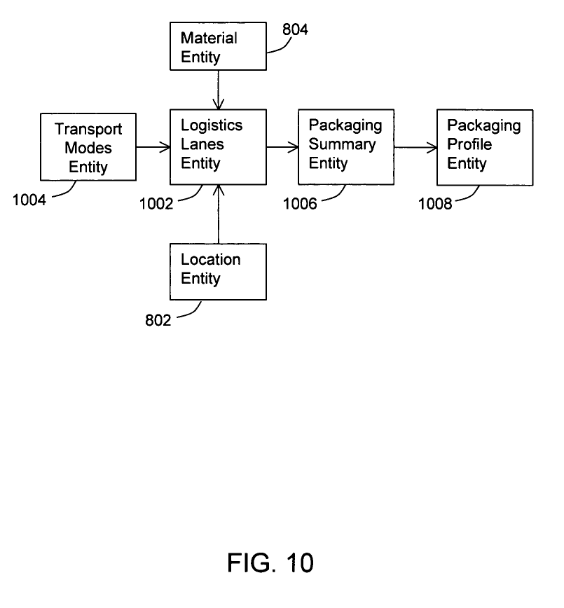

The costs and other information that need to be provided in cost calculation module 210 comprise three subject areas. These subject areas are packaging profile, logistics facts, and rates and fees. Packaging profile subject area maintains packaging details associated with various materials or products. The details include transport modes, pallet configuration, and currency of payment and other related information. FIG. 10 is a block diagram showing the various entities of the packaging profile subject area. Location entity 802 and material entity 804 are part of negotiator module 208 and are used to identify logistics lanes in a logistics lanes entity 1002 for a specified material or product that is to be shipped to a particular location. A transport modes entity 1004 identifies all the possible modes of transportation, such as air, ocean and freight that are possible for the specified logistics lane. A packaging summary entity 1006 stores the packaging profile of each valid combination of material, location and transportation mode. The packaging profile includes information such as currency, planned quantity, weight, freight cost per unit, storage costs per unit, etc., and is stored in packaging profile entity 1008, which also stores other details such as carton dimensions, empty carton weight, pallet dimensions, etc., for each packaging summary record.

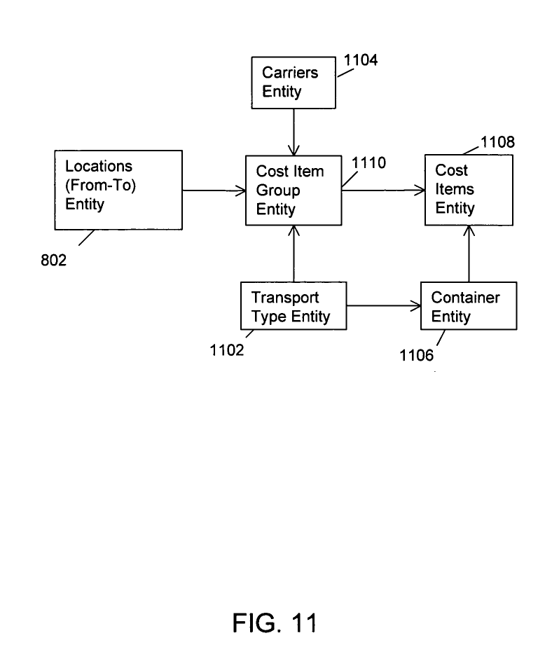

FIG. 11 is a block diagram of the various entities of the rates and fees subject area. A transport type entity 1102 identifies all the possible modes of transportation for location entity 802. A carriers entity 1104 represents all the possible logistics carriers used to transport materials or products. A container entity 1106 identifies all the possible container types of each transport type listed in transport type entity 1102. A cost item entity 1108 stores all the rates and fees associated with a product in a flexible, self-defining hierarchy. This hierarchy has been depicted in FIG. 7. A cost item group entity 1110 stores information such as transit time, currency and lead-time for each supplier, transport type, ship-from location and ship-to location.

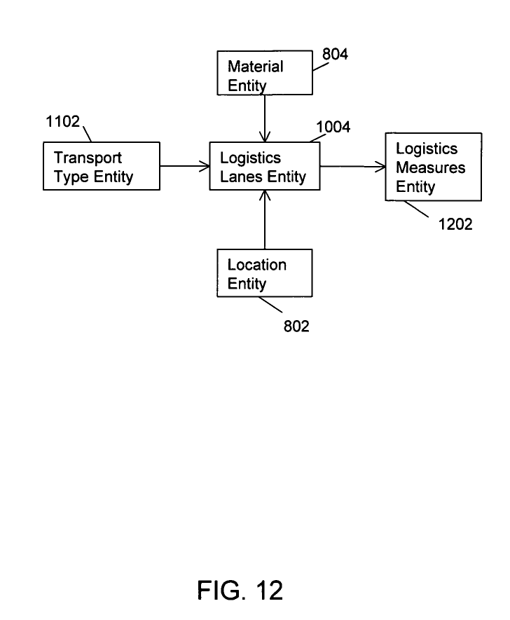

FIG. 12 is a block diagram of the various entities of the logistics facts subject area. Transport type entity 1102 identifies all possible modes of transport that are possible for a combination of product and location. A logistics measures entity 1202 stores attributes such as quantity, material, freight, and storage and should be purchase costs about a particular logistics lane across a time and product hierarchy. This entity is used to calculate and display the final should be purchase costs of a particular product and a particular time frame.

Once all the required information has been entered into the various subject areas, the should be purchase cost of a product can be calculated and displayed. The various subject areas include cost information provided by the supplier for a product. After the cost information is collected, various cost factors that are a part of the cost hierarchy, as shown in FIG. 7, are collected. Following this, the detailed costs are computed. The embedded costs are computed using the calculated detailed cost. Once the embedded costs are available, the should be purchase cost can be calculated. The should be purchase cost of a product can only be viewed by users who have the required authorization. For example, a supplier of a product is not authorized to view the should be purchase cost of a product. The should be purchase cost of a product is used by negotiators to negotiate the cost of a product with the supplier of the product. In order to negotiate the purchase cost of a product, the negotiator can send the supplier negotiated costs. This is an iterative process and the supplier and negotiator can negotiate on the costs until an agreement is reached. Application database 308 and exchange database 310 keep a track of all the costs that are provided by the supplier and the negotiator during the negotiation process. These historical costs can be referenced during subsequent negotiation processes.

It will be apparent to one skilled in the art that the various costs mentioned are for exemplary purposes only, and various other costs can also be used without deviating from the scope of the invention.

The system also supports the generation of email alerts when supplier information is inputted to negotiator module 208. Persons to whom the email alerts are sent can be specified by means of a user interface presented to an administrator of enterprise server 102. The administrator also has the option of selecting events that trigger the generation of email alerts. Typical events include, but are not limited to, the entering of supplier cost information, the sending of a negotiated price to a supplier, and the finalizing of a negotiated price.

An advantage of the present invention is that it guarantees a unique and effective purchase price for a product for any specified time period. This means that a negotiator is always guaranteed one true effective purchase price. In case data, such as cost information and detailed costs, is not available for a specified time period, then the system does not present a should be purchase cost to the negotiator. This ensures that the negotiator either has only one should be purchase cost with him to negotiate the purchase cost, or does not have any should be purchase cost, so as to avoid ambiguity. This reduces confusion and uncertainty in negotiating a price.

Another advantage of the present invention is that the manual effort required to gather and verify data from various disparate sources is eliminated. The present invention supports the collection of data from various data sources such as spreadsheets, databases and third party software such as enterprise resource planning software. Since data is not collected and collated manually, multiple versions or ‘truths’ of the same fact are not possible. This reduces or eliminates effort in the reconciliation of the submitted documents for payment, settlement and adjustment of payments due to multiple versions of the truth.

The present invention also eliminates the need of a manual request for quote (RFQ) process, which is very time consuming and requires multiple manual iterations. The process of iterations with a supplier of a product is automated by using alerts in the present invention.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer comprises a microprocessor. The microprocessor is connected to a communication bus. The computer also includes a memory. Memory may include Random Access Memory (RAM) and Read Only Memory (ROM). Computer system further comprises storage device, which can be a hard disk drive or a removable storage drive such as a floppy disk drive, optical disk drive and the like. The storage device can also be other similar means of loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software may be in the form of a collection of separate programs, a program module with a larger program, or a portion of a program module. The software might also include modular programming in the form of object-oriented programming. The processing of input data by the processing machine may be in response to user commands, to results of previous processing, or to a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

1. A method for computing should be purchase cost of a product, the method comprising the steps of:
a. collecting cost information of the product;
b. collecting a plurality of cost factors, each cost factor comprising packaging information and rates associated with the packaging information for the product;
c. computing a plurality of detailed costs, wherein each detailed cost is a function of at least one cost factor;
d. computing a plurality of embedded costs, wherein each embedded cost is a function of at least one detailed cost;
e. computing the should be purchase cost as a function of at least one embedded cost; and
f. presenting the cost information and the should be purchase cost of the product.

2. The method as recited in claim 1 further comprising the step of using the should be purchase cost of a product to negotiate a purchase price for the product with a supplier of the product.

3. The method as recited in claim 1, wherein the cost information is provided by a supplier of the product.

4. The method as recited in claim 1, wherein the cost information is provided by an information management system.

5. The method as recited in claim 1, wherein the cost information is provided by a user.

6. The method as recited in claim 1, wherein the cost factors are provided by an information management system.

7. The method as recited in claim 1, wherein the step of collecting the cost information further comprises storing the cost information.

8. The method as recited in claim 1, wherein the step of collecting the cost factors further comprises storing the cost factors.

9. The method as recited in claim 1, wherein the step of collecting cost information comprises collecting cost information only from authorized users.

10. The method as recited in claim 1, wherein the step of presenting the cost information and the should be purchase cost comprises presenting only to authorized users.

11. The method as recited in claim 1, wherein the step of collecting cost information and cost factors further comprise defining the period of validity for the cost information and the cost factors.

12. The method as recited in claim 1, wherein the step of computing the detailed cost comprises calculating the sum of the cost factors.

13. The method as recited in claim 1, wherein the step of computing the embedded cost comprises calculating the sum of the detailed costs.

14. The method as recited in claim 1, wherein the step of computing the should be purchase cost comprises calculating the sum of the embedded costs.

15. A method for computing should be purchase cost of a product that is time sensitive, the method comprising the steps of:
a. collecting cost information of the product, wherein the cost information has a predefined time period of validity;
b. collecting cost factors, each cost factor comprising packaging information and a rate associated with the packaging information for the product, wherein the cost factors have a predefined time period of validity;
c. computing a detailed cost as a function of at least one cost factor;
d. computing an embedded cost as a function of at least one detailed cost;
e. computing the should be purchase cost as a function of at least one embedded cost; and
f. presenting the cost information and the should be purchase cost of the product.

16. The method as recited in claim 15, wherein the cost information is provided by a supplier of the product.

17. The method as recited in claim 15, wherein the cost information is provided by an information management system.

18. The method as recited in claim 15, wherein the cost factors are provided by a user.

19. The method as recited in claim 15, wherein the cost factors are provided by an information management system.

20. The method as recited in claim 15, wherein the step of collecting cost information comprises collecting cost information only from authorized users.

21. The method as recited in claim 15, wherein the step of presenting the cost information and the total cost comprises presenting only to authorized users.

22. A system for computing should be purchase cost of a product, the system comprising:
a. at least one data processing system for inputting, searching, extracting and displaying cost information and cost factors related to the product;
b. at least one server having an interface for communicating over a computer network, the server receiving cost information and cost factors related to the product from the data processing system, forming relationships between the cost information and cost factors related to the product, processing the cost information to compute should be purchase cost of the product, and providing the should be purchase cost of the product to the data processing system; and
c. at least one memory device for storing cost information for access by the server.

23. The system as recited in claim 22 wherein the server comprises:
a. an application server, the application server providing applications and interfaces for receiving cost information and cost factors; and
b. a database server, the database server storing the cost information and cost factors and providing relationships between the cost information and cost factors.

24. A computer program product for use with a computer, the computer program product comprising a computer usable medium having a computer readable program code embodied therein for computing the should be purchase cost of a product, the computer program product performing the steps of:
a. collecting cost information of the product;
b. collecting cost factors, each cost factor comprising packaging information and a rate associated with the packaging information for the product;
c. computing a detailed cost as a function of at least one cost factor;
d. computing an embedded cost as a function of at least one detailed cost;
e. computing the should be purchase cost as a function of at least one embedded cost; and
f. presenting the cost information and the should be purchase cost of the product.
